(19) United States
(12) Patent Application Publication
(10) Pub. No.: US 2025/0263979 A1
(43) Pub. Date: Aug. 21, 2025

(54) RECIPROCATING TYPE PULL ROD DRIVING APPARATUS AND CURTAIN SYSTEM INCLUDING SAME

(71) Applicant: Tsung-Jung Chen, New Taipei City (TW)

(72) Inventor: Tsung-Jung Chen, New Taipei City (TW)

(21) Appl. No.: 18/856,990

(22) PCT Filed: Mar. 24, 2023
(86) PCT No.: PCT/CN2023/083840

§ 371 Date: Oct. 15, 2024

Related U.S. Application Data
(60) Provisional application No. 63/332,736, filed on Apr. 20, 2022.

(51) Int. Cl. E06B 9/78

(52) U.S. Cl. CPC E06B 9/78

(57) ABSTRACT

A reciprocating type pull rod driving apparatus, including a housing, a shaft rod, a driving wheel, a chain, and an operating assembly. One end of the shaft rod extends to the housing. The driving wheel is arranged on the shaft rod. The chain is meshed with multiple engagement teeth of the driving wheel. The operating assembly is connected to the chain and configured to operate the chain to drive the driving wheel to rotate. A distance between a radial outer end edge of the driving wheel and an inner wall of the housing is greater than or equal to a thickness of the chain, and a quantity of driving wheel teeth that the chain is meshed with is less than a half of a total quantity of teeth.

### REFERENCE TO RELATED APPLICATION

This application is the National Phase of PCT International Application No. PCT/CN2023/083840, filed on Mar. 24, 2023, which claims priority under 35 U.S.C. 119(e) to U.S. Provisional Application No. 63/332,736, filed on Apr. 20, 2022, all of which are hereby expressly incorporated by reference into the present application.

### BACKGROUND

### Technical Field

The instant disclosure relates to a reciprocating type pull rod driving apparatus and a curtain system including same, and in particular to a manual pull rod driving apparatus applicable to the deployment or retraction of vertical lifting or horizontal sliding curtains, awnings, screens, or other soft materials.

### Related Art

Most common curtain systems in the market, whether they are lifting roller curtains or horizontally sliding curtains, are mostly driven to open or close by a drawstring. However, due to the travel distance of the curtains, the pull cords must be long enough. Unfortunately, such long pull cords can sometimes lead to accidents, especially for young children, such as pull cords getting tangled around children's limbs or necks.

Taking a conventional roller blind as an example, referring to FIG. 1, which is a cross-sectional view of a conventional roller blind drive assembly. As shown in FIG. 1, a sprocket 91 is mounted on a roller 90, and a bead chain 92 engages with the sprocket 91. Therefore, the user can drive the roller 90 to rotate clockwise or counterclockwise by pulling the two ends of the bead chain 92, thereby winding or releasing the roller blind.

Furthermore, still as shown in FIG. 1, to ensure that the bead chain 92 is tightly engaged with the sprocket 91 so as to prevent the bead chain 92 from slipping off the sprocket 91, the gap between the inner wall of the housing 93 and the radial outer end edge of the sprocket 91 is usually set to be very small, or even almost completely in contact. Therefore, in addition to driving the bead chain 92 to fully fall into the teeth of the sprocket 91, the inner wall surface of the housing 93 can also keep the bead chain 92 in the teeth of the sprocket 91 throughout the entire driving process, preventing the bead chain 92 from coming off the teeth.

Therefore, conventional window curtain systems driven by pull cords cannot shorten the length of the pull cord, and the danger of window curtain pull cords to life safety always exists. Therefore, the new window curtain safety standard regulations passed by the Window Covering Manufacturers Association (WCMA) in the United States stipulate that all physical retail stores in the United States will be prohibited from selling pull cord window curtains starting in 2019, and only “cordless” window curtains can be sold (online stores are exempt). However, existing “cordless” curtains still have shortcomings, such as the difficulty in adjusting the speed of rolling, the difficulty in accurately positioning the curtain covering, the unsuitability for installation at high heights, lower reliability and service life, and relatively high prices.

### SUMMARY

A main object of the instant disclosure is to provide a reciprocating type pull rod driving apparatus and a curtain system including the same, so as to convert the conventional pull cord drive into a pull rod drive through an innovative mechanism, thereby driving the window curtain to rise or slide horizontally in a safer, more reliable, more convenient, and more cost-effective manner.

To achieve the above object, the reciprocating type pull rod driving apparatus of the instant disclosure mainly includes a housing, a shaft rod, a driving wheel, a chain, and an operating assembly, where one end of the shaft rod extends to the housing; the driving wheel is arranged on the shaft rod and accommodated in the housing; the driving wheel includes a plurality of engagement teeth; the chain is engaged with the plurality of engagement teeth of the driving wheel; and the operating assembly is connected to the chain and suitable for operating the chain to rotate the driving wheel. A distance between a radial outer end edge of the driving wheel and an inner wall of the housing is greater than or equal to a thickness of the chain. A quantity of the plurality of engagement teeth of the driving wheel that the chain is engaged with is less than or equal to a half of a total quantity of the plurality of engagement teeth.

Therefore, in the instant disclosure, by setting the distance between the radial outer end edge of the drive wheel and the inner wall of the housing to be greater than or equal to the thickness of the chain, allows the chain to be easily disengaged from and re-engaged with the drive wheel. Moreover, in the instant disclosure, the quantity of the plurality of engagement teeth of the driving wheel that the chain is engaged with is set to be less than a half of the total quantity of the plurality of engagement teeth, thereby reducing the quantity of teeth of the drive wheel engaged by the chain. In this way, the chain can be entirely disengaged from the driving wheel more easily and can also be easily reset to again pull the driving wheel, so that the chain can perform a reciprocating action, changing the single-bite operation of the conventional long pull cord, thus significantly shortening the chain length and significantly improving the operating convenience and safety.

To achieve the above object, a curtain system including the reciprocating type pull rod driving apparatus of the instant disclosure mainly includes the reciprocating type pull rod driving apparatus and curtain cloth, where the curtain cloth is driven by the reciprocating type pull rod driving apparatus to be alternatively wound onto or unwound from the shaft rod. In other words, the aforementioned reciprocating type pull rod driving apparatus can be arranged on a vertically lifting roller blind. In addition, the instant disclosure is not limited to curtains, other rolling purdahs, tarpaulins, or other equivalent soft material parts are all applicable to the instant disclosure.

To achieve the above object, a curtain system including the reciprocating type pull rod driving apparatus of the instant disclosure mainly includes a horizontal guide rail, at least one sliding member, a drawstring, at least one piece of curtain cloth, and the reciprocating type pull rod driving apparatus, where the drawstring is wound around the shaft rod of the reciprocating type pull rod driving apparatus; and the reciprocating type pull rod driving apparatus is suitable for pulling the drawstring through the shaft rod, thereby driving the at least one sliding member to pull the at least one piece of curtain cloth to slide horizontally. In other words, the aforementioned reciprocating type pull rod driving apparatus can also be configured in a horizontally opening curtain, screen, or awning system, and is applicable to both single-opening and double-opening horizontal configurations.

### BRIEF DESCRIPTION OF THE DRAWINGS

FIG. 1 is a cross-sectional view of a conventional roller blind drive assembly.

FIG. 2 is a perspective view of a first embodiment of a reciprocating type pull rod driving apparatus of the instant disclosure applied to a roller curtain system.

FIG. 3A is a cross-sectional view of the first embodiment of the reciprocating type pull rod driving apparatus of the instant disclosure in a static state.

FIG. 3B is a cross-sectional view of the first embodiment of the reciprocating type pull rod driving apparatus of the instant disclosure in an operating state.

FIG. 4 is a side view of the limiting member and the stop member of the first embodiment of the reciprocating type pull rod driving apparatus of the instant disclosure.

FIG. 5 is a cross-sectional view of a second embodiment of the reciprocating type pull rod driving apparatus of the instant disclosure.

FIG. 6 is a cross-sectional view of a third embodiment of the reciprocating type pull rod driving apparatus of the instant disclosure.

FIG. 7A is a perspective view of the chain detachment mechanism and the driving wheel in the third embodiment of the reciprocating type pull rod driving apparatus of the instant disclosure.

FIG. 7B is an exploded view of the chain detachment mechanism and the driving wheel in the third embodiment of the reciprocating type pull rod driving apparatus of the instant disclosure.

FIG. 8A is a cross-sectional view taken along A-A of FIG. 7A, in which the reciprocating type pull rod driving apparatus is in a static state.

FIG. 8B is a cross-sectional view taken along A-A of FIG. 7A, in which the reciprocating type pull rod driving apparatus is in an operating state.

FIG. 9A is an enlarged cross-sectional view of a chain detachment mechanism and the driving wheel in a fourth embodiment of the reciprocating type pull rod driving apparatus of the instant disclosure.

FIG. 9B is an enlarged cross-sectional view of a chain detachment mechanism and the driving wheel in a fifth embodiment of the reciprocating type pull rod driving apparatus of the instant disclosure.

FIG. 10A is a perspective view of a sixth embodiment of the reciprocating type pull rod driving apparatus of the instant disclosure.

FIG. 10B is a perspective view of a sixth embodiment of the reciprocating type pull rod driving apparatus of the instant disclosure, with a housing removed.

FIG. 10C is a perspective view of the chain detachment mechanism and the driving wheel in the sixth embodiment of the reciprocating type pull rod driving apparatus of the instant disclosure.

FIG. 11A is a perspective view of the chain detachment mechanism and the driving wheel in a seventh embodiment of the reciprocating type pull rod driving apparatus of the instant disclosure.

FIG. 11B is a diagram of the seventh embodiment of the reciprocating type pull rod driving apparatus of the instant disclosure applied to a curtain system that is horizontally opened in two opposite directions.

FIG. 12 is a diagram of the first embodiment of the reciprocating type pull rod driving apparatus of the instant disclosure applied to another roller curtain system.

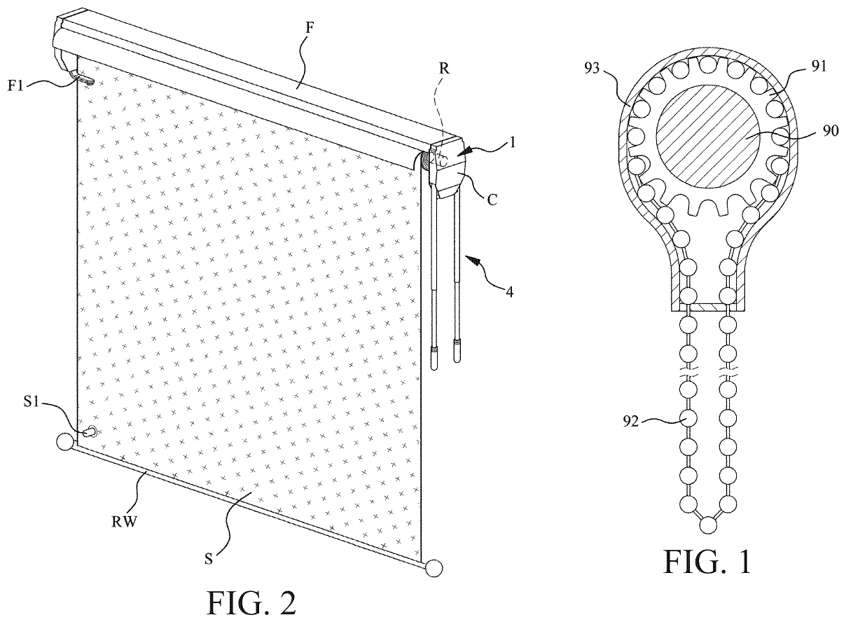

### DETAILED DESCRIPTION

Before a reciprocating type pull rod driving apparatus of the instant disclosure and a curtain system including such apparatus are described in detail in embodiments, it should be particularly noted that in the following description, similar components are denoted by the same reference numerals. In addition, the drawings of the instant disclosure are illustrative only, and are not necessarily drawn to scale, and all details are not necessarily presented in the drawings.

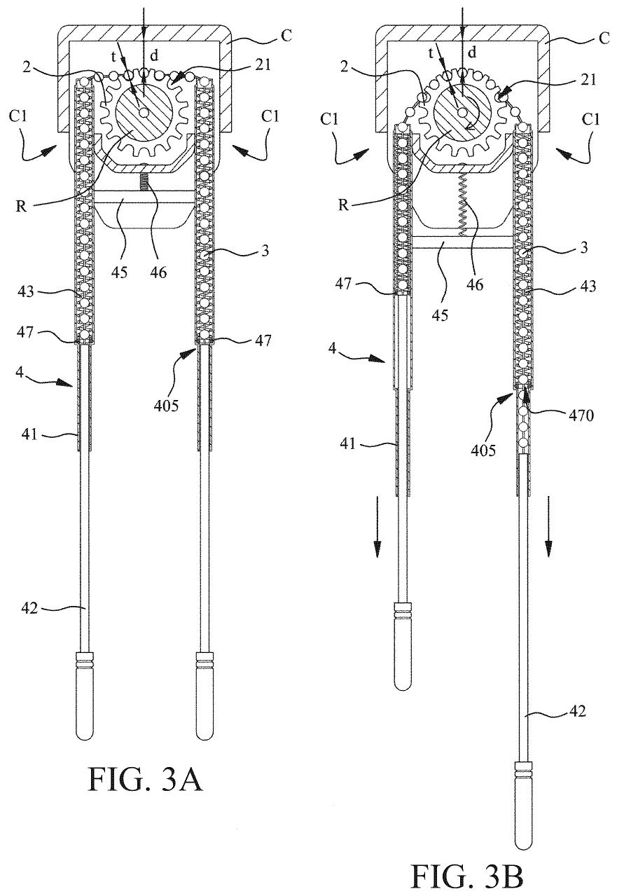

Reference is made to FIG. 2, FIG. 3A, and FIG. 3B, where FIG. 2 is a perspective view of a first embodiment of a reciprocating type pull rod driving apparatus of the instant disclosure applied to a roller curtain system, FIG. 3A is a cross-sectional view of the first embodiment of the reciprocating type pull rod driving apparatus of the instant disclosure in a static state, and FIG. 3B is a cross-sectional view of the first embodiment of the reciprocating type pull rod driving apparatus of the instant disclosure in an operating state. As shown in the figures, the reciprocating type pull rod driving apparatus 1 of the instant disclosure mainly includes a fixed bracket F, a housing C, a shaft rod R, a driving wheel 2, a chain 3, and an operating assembly 4.

The fixed bracket F is arranged on a wall (not shown in the figures). The housing C is arranged on the fixed bracket F. The housing C includes two openings C1, which are respectively provided on two corresponding sides. The shaft rod R is pivotally arranged on the fixed bracket F. One end of the shaft rod R extends into the housing C. A portion of the shaft rod R exposed outside the housing C is configured to wind curtain cloth S. It is particularly noted that, the shaft rod R in this embodiment is a shaft rod R with rotational damping, that is, once the shaft rod R is rotated by an external force, the damping inside the shaft rod R can prevent the shaft rod R from rotating due to the gravity of the curtain cloth S. In addition, the driving wheel 2 is arranged at one end of the shaft rod R and accommodated in the housing C. The driving wheel 2 includes a plurality of engagement teeth 21. The chain 3 is engaged with the plurality of engagement teeth 21 of the driving wheel 2. The operating assembly 4 is connected to the chain 3 and suitable for operating the chain 3 to drive the driving wheel 2 to rotate.

The operating assembly 4 in this embodiment mainly includes two sleeves 41, two pull rods 42, two springs 43, a connecting member 45, an elastic restoring element 46, and two blocking pieces 47. The two pull rods 42 are respectively connected to two ends of the chain 3. The two sleeves 41 also respectively sleeve the two ends of the chain 3. The two springs 43 and the two blocking pieces 47 are respectively accommodated in the two sleeves 41. Each of the sleeves 41 has a step portion 405, the blocking pieces 47 are abut against the step portions 405 of the corresponding sleeves 41, one end of each of the springs 43 abuts against the corresponding sleeve 41 and the other end abuts against the corresponding blocking piece 47. Moreover, each of the blocking pieces 47 includes a bored hole 470, and two ends of the chain 3 pass through the bored hole 470. In addition, the connecting member 45 may be a plate or a rod, with two ends respectively connected to the two sleeves 41, while two ends of the elastic restoring element 46 are respectively connected to the connecting member 45 and the housing C, and the elastic restoring element 46 is configured to apply bias to the connecting member 45 to drive it closer to the housing C. The chain 3 in this embodiment is a bead chain, but the instant disclosure is not limited thereto. For example, a belt or other equivalent power transmission components are all applicable to the instant disclosure.

The operation of this embodiment is described as follows: referring to FIG. 3A, in a static state, that is, when the drive wheel 2 is not rotating, a quantity of the plurality of engagement teeth 21 of the driving wheel 2 that the chain 3 is engaged with is less than one third of a total quantity of the engagement teeth 21; and a distance d between a radial outer end edge of the driving wheel 2 and an inner wall of a top surface of the housing C is greater than a thickness t of the chain 3. When winding the curtain cloth S, a user only needs to pull the right pull rod 42, as shown in FIG. 3B. At this moment, the pull rod 42 pulls the chain 3, the chain 3 moves down after passing through the bored hole 470 of the blocking piece 47, the chain 3 in turn drives the driving wheel 2 to rotate clockwise, and the curtain cloth S is wound on the shaft rod R. Moreover, the other end of the chain 3 pulls the pull rod 42 on the other side, so that the pull rod 42, together with the corresponding blocking piece 47, moves up and compresses the corresponding spring 43, thereby accumulating restoring force In addition, the two sleeves 41, together with the connecting member 45, will also be subjected to a force to descend, and at this moment, the quantity of the teeth of the driving wheel 2 that the chain 3 is engaged with is still less than a half of the total quantity of the engagement teeth 21. In other words, since the quantity of the teeth of the driving wheel 2 that the chain 3 is engaged with is more than that in the static state, power is transmitted more reliable, and the chain 3 is less likely to slip off from the driving wheel 2.

Subsequently, if it is still necessary to continue winding the curtain cloth S, the user only needs to release the corresponding pull rod 42. At this moment, the elastic restoring element 46 assists in pulling the corresponding sleeve 41, the corresponding pull rod 42 and the connecting member 45 to return to their original positions, and the chain 3 automatically slips off from the engagement teeth 21 of the driving wheel 2, while the compressed spring 43 in the sleeve 41 releases its elastic force to push the chain 3 to return to its original position, as shown in FIG. 3A. In other words, in this embodiment, after the pull rod 42 is pulled down and released, it will automatically return to its original position, and there is no need for the user to manually move the pull rod 42 upward to return it to its original position. Moreover, the user only needs to pull down the pull rod 42 again, as described in the previous paragraph, to make the apparatus in a state shown in FIG. 3B, so that the shaft rod R can be pulled again to wind the curtain cloth S. By continuously reciprocating in this way, the curtain cloth S can be continuously wound.

On the other hand, if it is necessary to unwind (release) the curtain cloth S, the user only needs to pull the pull rod 42 on the other side and perform the aforementioned operation to continuously release the curtain cloth S.

Overall, in this embodiment, since the distance d between the radial outer end edge of the driving wheel 2 and the inner wall of the top surface of the housing C is set to be greater than the thickness t of the chain 3, the chain 3 can be entirely disengaged from the driving wheel 2, thereby realizing reciprocating operation. Moreover, in a state of not driving the driving wheel 2, in this embodiment, the quantity of the teeth of the driving wheel 2 that the chain 3 is engaged with is set to be less than one third of the total quantity of the engagement teeth, that is, reducing the number of teeth of the chain 3 engaged with the drive wheel 2. According to this, the chain 3 can be more easily detached from the drive wheel 2 and can be easily returned to its original position and then pull the drive wheel 2 again, so that the chain 3 can form a reciprocating operation.

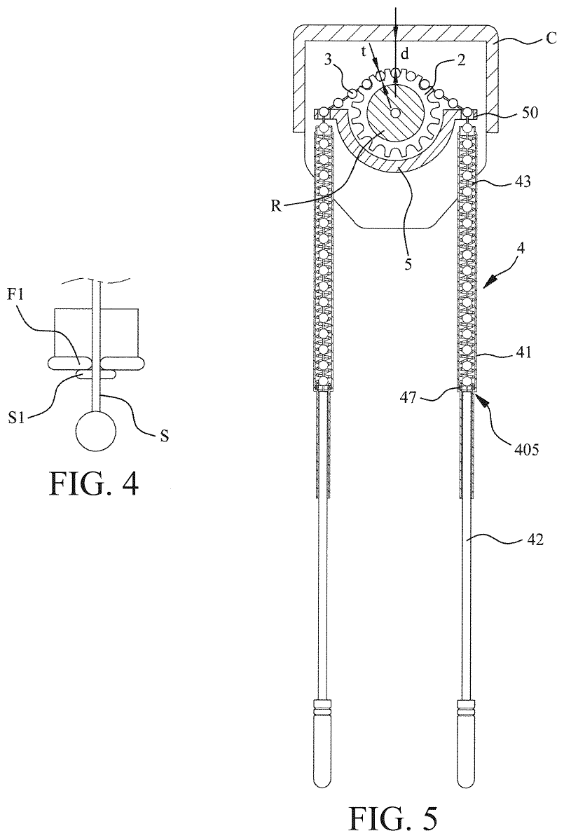

Reference is made to both FIG. 2 and FIG. 4, where FIG. 4 is a side view of a limiting member and a stop member of the first embodiment of the reciprocating type pull rod driving apparatus of the instant disclosure. As shown in the figure, the limiting member F1 is provided on one side of the fixed bracket F, and the stop member S1 is arranged on a lower side of the curtain cloth S. When the curtain cloth S is wound on the shaft rod R and the stop member S1 abuts against the limiting member F1, the limiting member F1 blocks the stop member S1, so that the curtain cloth S cannot be further wound on the shaft rod R, thereby preventing the curtain cloth S from being overwound and causing the shaft rod R to idle, or even preventing the curtain cloth S from being excessively wound so that the lower gravity rod RW jams the fixed bracket F, causing damage to the apparatus.

Reference is made to FIG. 5, where FIG. 5 is a cross-sectional view of a second embodiment of the reciprocating type pull rod driving apparatus of the instant disclosure. The main difference between this embodiment and the aforementioned first embodiment is that this embodiment further comprises a support seat 5, which is disposed below the drive wheel 2; two ends of the support seat 5 are each provided with a through hole 50; two ends of the chain 3 respectively pass through the through holes 50 in the two ends of the support seat 5; while the operating assembly 4 is suspended below the support seat 5. Accordingly, in this embodiment, the support seat 5 can be used to spread apart the chain 3 to reduce the number of teeth of the chain 3 engaged with the drive wheel 2, so that the chain 3 can be more easily disengaged from the drive wheel 2 and can be easily returned to its original position and then pull the drive wheel 2 again. Moreover, the support seat 5 can also fix the operating assembly 4, so that the operating assembly 4 will not swing during operation, and the connecting member 45 and the elastic restoring member 46 in the previous embodiment can be omitted.

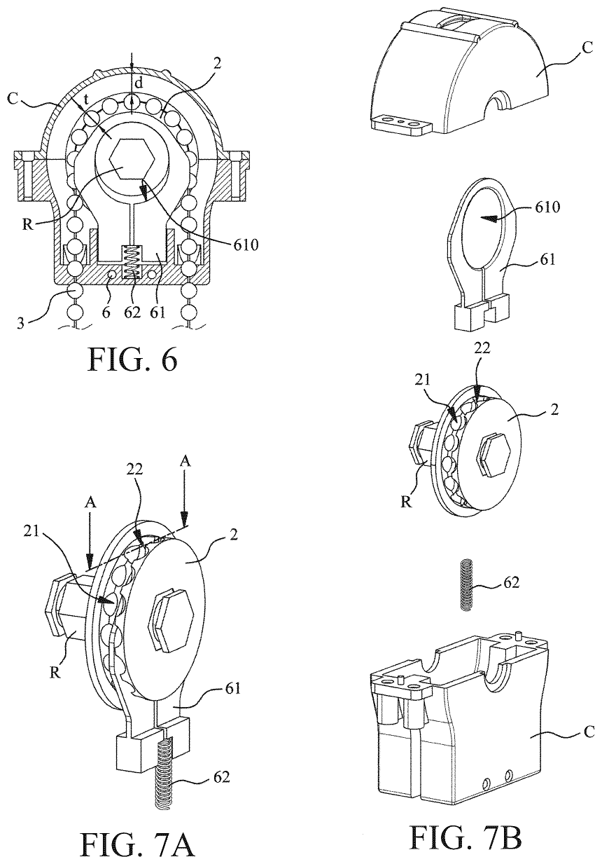

Reference is made to FIG. 6, FIG. 7A, and FIG. 7B, where FIG. 6 is a cross-sectional view of a third embodiment of the reciprocating type pull rod driving apparatus of the instant disclosure, FIG. 7A is a perspective view of a chain detachment mechanism and a driving wheel in the third embodiment of the reciprocating type pull rod driving apparatus of the instant disclosure, and FIG. 7B is an exploded view of the chain detachment mechanism and the driving wheel in the third embodiment of the reciprocating type pull rod driving apparatus of the instant disclosure. The main difference between this embodiment and the aforementioned first embodiment is that this embodiment further employs chain detachment mechanism 6, which is configured to push the chain 3 out of the engagement teeth 21 of the driving wheel 2, to assist in returning the pull rod (not shown in the figure) to its original position.

It is further noted that the chain detachment mechanism 6 in this embodiment includes a U-shaped baffle 61 and an elastic body 62. The U-shaped baffle 61 includes a long slot 610. The driving wheel 2 includes an outer circumferential groove 22 in communication with the plurality of engagement teeth 21. The U-shaped baffle 61 sleeves the outer circumferential groove 22 of the driving wheel 2, and the U-shaped baffle 61 can slide relative to the driving wheel 2 through the long slot 610. The elastic body 62 is a compression spring, but it can also be a leaf spring or other equivalent element that can provide elasticity or restoration, which is accommodated in the housing C, with one end abutting against the housing C and the other end abutting against the U-shaped baffle 61, and constantly drives the U-shaped baffle 61 upward to push the chain 3 outward and at least partially separate from the plurality of engagement teeth 21. Similarly, in this embodiment, the distance d between the radial outer end edge of the driving wheel 2 and the inner wall of the top surface of the housing C is greater than the thickness t of the chain 3, so the chain 3 is allowed to be entirely disengaged from the plurality of engagement teeth 21 of the driving wheel 2.

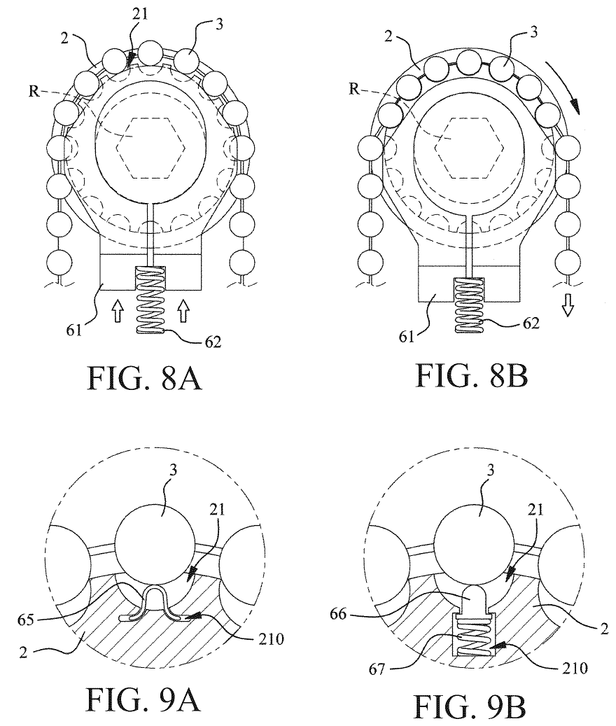

Reference is made to both FIG. 8A and FIG. 8B, where FIG. 8A is a cross-sectional view taken along A-A of FIG. 7A, in which the reciprocating type pull rod driving apparatus is in a static state, and FIG. 8B is a cross-sectional view taken along A-A of FIG. 7A, in which the reciprocating type pull rod driving apparatus is in an operating state. When the pull rod (not shown in the figures) is not pulled downward, the elastic body 62 stretched, causing the U-shaped baffle 61 to move upward and abut against the chain 3, allowing the chain 3 to disengage from the engagement teeth 21, as shown in FIG. 8A. However, when a user pulls down the pull rod (not shown in the figures), a downward force exceeds the elastic force of the elastic body 62, and the chain 3 makes the U-shaped baffle 61 move downward, allowing the chain 3 to engaged with the engagement teeth 21, thereby driving the driving wheel 2 to rotate, as shown in FIG. 8B.

As described above, in this embodiment, when the driving wheel 2 is driven to rotate by the chain 3, the quantity of the engagement teeth 21 of the driving wheel 2 that the chain 3 is engaged with is less than or equal to a half of the total quantity of the engagement teeth 21; and when the driving wheel is not rotating, the chain detachment mechanism 6 pushes out the chain 3 and causes the chain 3 be at least partially disengaged from the engagement teeth 21. In other words, the chain detachment mechanism 6 of this embodiment acts as a clutch. When a user pulls down the pull rod, the chain detachment mechanism 6 can cause the chain 3 be engaged with the engagement teeth 21 of the driving wheel 2; and when the user releases the pull rod, the chain detachment mechanism 6 can causes the chain 3 be disengaged from the engagement teeth 21 of the driving wheel 2, while the pull rod (not shown in the figures) and the chain 3 can be automatically return to their original positions, which is convenient for the user to operate and can significantly reduce noise.

Reference is made to FIG. 9A, where FIG. 9A is an enlarged cross-sectional view

of a chain detachment mechanism and a driving wheel in a fourth embodiment of the reciprocating type pull rod driving apparatus of the instant disclosure. The chain detachment mechanism 6 in this embodiment includes a plurality of convex leaf springs 65 that are respectively accommodated in accommodating grooves 210 in the plurality of engagement teeth 21, and each of the convex leaf springs 65 constantly pushes the chain 3 outward and causes it be at least partially disengaged from the engagement teeth 21.

Reference is made to FIG. 9B, where FIG. 9B is an enlarged cross-sectional view of a chain detachment mechanism and a driving wheel in a fifth embodiment of the reciprocating type pull rod driving apparatus of the instant disclosure. The chain detachment mechanism 6 in this embodiment includes a plurality of top columns 66 and a plurality of springs 67 that are respectively accommodated in accommodating grooves 210 in the plurality of engagement teeth 21, and each of the top columns 66 constantly pushes the chain 3 outward and causes it be at least partially disengaged from the engagement teeth 21 by the tension of the spring 67. Accordingly, the chain detachment mechanism 6 of the instant disclosure is not limited to the aforementioned embodiments, and any mechanisms or assemblies that can push the chain 3 outward and causes it be at least partially disengaged from the engagement teeth 21 when the chain 3 is not subjected to a force is included in the scope of the instant disclosure.

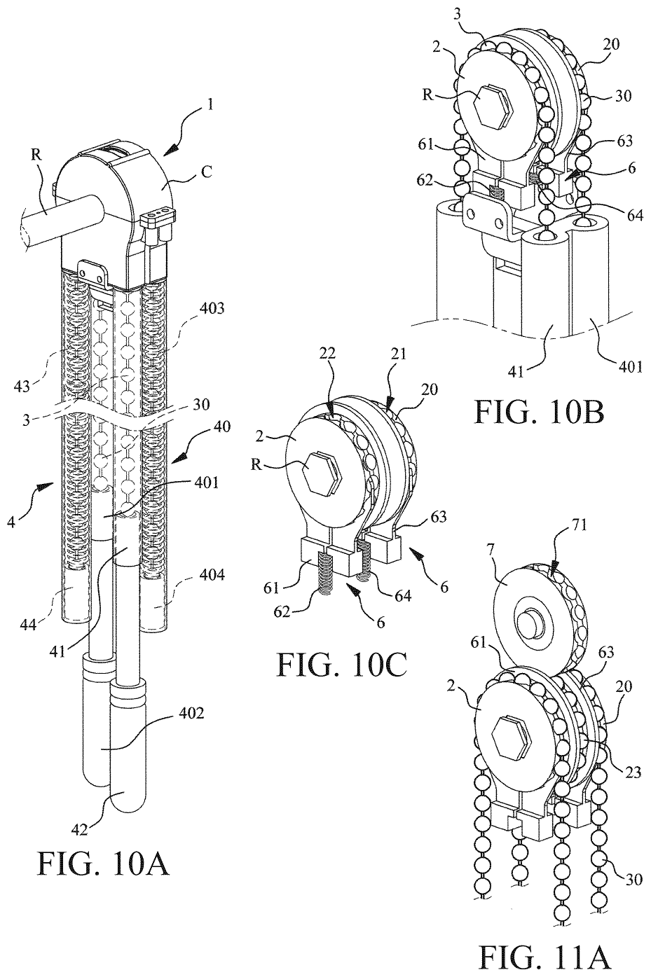

Reference is made to FIG. 10A, FIG. 10B, and FIG. 10C, where FIG. 10A is a perspective view of a sixth embodiment of the reciprocating type pull rod driving apparatus of the instant disclosure, FIG. 10B is a perspective view of a sixth embodiment of the reciprocating type pull rod driving apparatus of the instant disclosure, with a housing removed, and FIG. 10C is a perspective view of a chain detachment mechanism and a driving wheel in the sixth embodiment of the reciprocating type pull rod driving apparatus of the instant disclosure. In order to allow the pull rod 42 to return to its original position more smoothly, that is, as long as the user pulls down the pull rod 42 intermittently during operation, the curtain cloth S can be continuously wound on the shaft rod R or continuously unwound from the shaft rod R, the instant disclosure provides a configuration of double driving wheels in the sixth embodiment.

It is further noted that, in this embodiment, two sets of reciprocating type pull rod driving apparatuses such as the third embodiment described above are integrated, which include two driving wheels 2 and 20, two chains 3 and 30, two operating assemblies 4 and 40, and two chain push-out assemblies 6. The two driving wheels 2 and 20 are both arranged on the shaft rod R. The two chains 3 and 30 are respectively engaged with the two driving wheels 2 and 20. The two operating assemblies 4 and 40 are hinged to a lower end surface of the housing C. Each of the chain push-out assemblies 6 includes U-shaped baffles 61 and 63 and elastic bodies 62 and 64. The U-shaped baffles 61 and 63 are respectively fitted on the outer circumferential grooves 22 of the two driving wheels 2 and 20. These U-shaped baffles 61 and 63 can slide relative to the two driving wheels 2 and 20. One end of each of the elastic bodies 62 and 64 abuts against the housing C, and the other end of each of the elastic bodies respectively abuts against each of the two U-shaped baffles 61 and 63 and constantly drives each of the two U-shaped baffles 61 and 63 to respectively push the two chains 3 and 30 upward and cause the chains 3 and 30 be at least partially disengaged from the plurality of the engagement teeth 21 of the two driving wheels 2 and 20.

Each the operating assemblies 4 and 40 includes two sleeves 41 and 401, stop blocks 44 and 404, pull rods 42 and 402, and springs 43 and 403. The two pull rods 42 and 402 are respectively connected to one end of each of the two chains 3 and 30 and are located at different sides. The two stop blocks 44 and 404 are respectively connected to the other end of each of the two chains 3 and 30 and also located at different sides. Two ends of each of the chains 3 and 30 are respectively sleeved with the sleeves 41 and 401. The springs 43 and 403 are accommodated in the sleeves 41 and 401 that are on the same side as the stop blocks 44 and 404, where one end of each of the springs 43 and 403 abuts against each of the sleeves 41 and 401 and the other end abuts against each of the stop blocks 44 and 404.

Accordingly, in this embodiment, since the two pull rods 42 and 402 are arranged at different sides, that is, one on a front side and the other on a rear side, when the two pull rods 42 and 402 are pulled respectively, the shaft rod R can be driven to rotate in different directions. In other words, after the pull rod 42 is pulled, the shaft rod R rotates clockwise; and after the pull rod 402 is pulled, the shaft rod R rotates counterclockwise. In addition, with the help of the elastic force of the elastic bodies 62 and 64, when the two pull rods 42 and 402 are pulled respectively, the reset action of the U-shaped baffles 61 and 63 will cause the chains 3 and 30 to be disengaged from the driving wheels 2 and 20, while the springs 43 and 403 will push the stop blocks 44 and 404 to reset, thereby causing the pull rods 42 and 402 to be reset automatically. Therefore, during operation, the user only needs to pull down the pull rods 42 and 402 intermittently to continuously wind or unwind the curtain cloth.

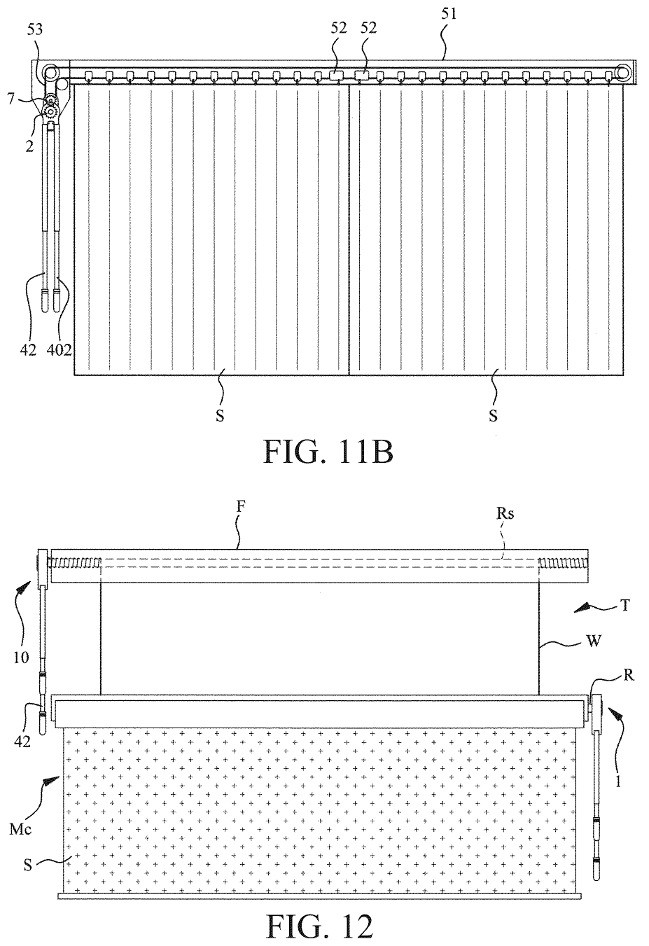

Reference is made to both FIG. 11A and FIG. 11B, where FIG. 11A is a perspective view of a chain detachment mechanism and a driving wheel in a seventh embodiment of the reciprocating type pull rod driving apparatus of the instant disclosure, and FIG. 11B is a diagram of the seventh embodiment of the reciprocating type pull rod driving apparatus of the instant disclosure applied to a curtain system that is horizontally opened in two opposite directions. The following embodiments are used to illustrate that the instant disclosure can also be applied to horizontal pull rod curtains. As shown in FIG. 11A, the main difference between this embodiment and the sixth embodiment is that this embodiment further includes a driven wheel 7, and convex teeth 23 that can be engaged with the driven wheel 7 are arranged between the driving wheels 2 and 20. Accordingly, when the driving wheels 2 and 20 are driven to rotate, the driven wheel 7 can be driven to rotate, and the speed can be increased or decreased by adjusting the ratio of the number of teeth between the driven wheel 7 and the drive wheels 2, 20.

In addition, as shown in FIG. 11B, the curtain system in this embodiment includes a horizontal guide rail 51, two sliding members 52, a drawstring 53, and two pieces of curtain cloth S, where the two sliding members 52 are coupled to the horizontal guide rail 51, the drawstring 53 is connected to the two sliding members 52, and the two pieces of curtain cloth S are coupled to the horizontal guide rail 51 and are respectively connected to the two sliding members 52. Furthermore, the drawstring 53 is fitted into groove 71 of the driven wheel 7. Accordingly, the reciprocating type pull rod driving apparatus 1 can pull the drawstring 53 through the pull rods 42 and 402, thereby driving the sliding members 52 to pull the curtain cloth S to slide horizontally. In short, the reciprocating type pull rod driving apparatus 1 provided in the instant disclosure is also applicable to curtain systems that are horizontally opened in two opposite directions or other similar awning or screen systems. The instant disclosure is also not limited to a system that is horizontally opened in two opposite directions, and any horizontal sliding systems that are driven by a drawstring or a chain are applicable to the instant disclosure.

Reference is made to FIG. 12, where FIG. 12 is a diagram of the first embodiment of the reciprocating type pull rod driving apparatus of the instant disclosure applied to another roller curtain system. The main difference between this embodiment and the aforementioned roller curtain system is that: the reciprocating type pull rod driving apparatus 1 on the right can be configured to control winding or unwinding of the curtain cloth S of a roller curtain module Mc, as described in the foregoing embodiment. The reciprocating type pull rod driving apparatus 10 on the left is configured to lift the entire roller curtain module Mc, that is, a hollow region T can be represented in an upper section of the curtain. A rolling bar Rs is pivotally connected to the fixed bracket F, the reciprocating type pull rod driving apparatus 10 is arranged at one end of the rolling bar Rs, two steel ropes W are wound on the rolling bar Rs, and one end of each of the steel ropes W is connected to the roller curtain module Mc. Accordingly, by operating the reciprocating type pull rod driving apparatus 10, the rolling bar Rs can be driven to wind or release the steel ropes W, and thus the entire roller curtain module Mc can be raised or lowered.

The foregoing embodiments are merely examples for ease of description, and the scope of the claims in the instant disclosure should be based on the scope of the claims, and is not limited to the foregoing embodiments.

1. A reciprocating type pull rod driving apparatus, comprising:
a housing;
a shaft rod, with one end extending to the housing;
a driving wheel, kinematically connected with the shaft rod and accommodated in the housing, the driving wheel comprising a plurality of engagement teeth;
a chain, engaged with the plurality of engagement teeth of the driving wheel; and
an operating assembly, connected to the chain for operating the chain to rotate the driving wheel, wherein
a distance between a radial outer end edge of the driving wheel and an inner wall of the housing is greater than or equal to a thickness of the chain, and a quantity of the plurality of engagement teeth of the driving wheel that the chain is engaged with is less than or equal to a half of a total quantity of the plurality of engagement teeth.

2. The reciprocating type pull rod driving apparatus according to claim 1, wherein the operating assembly comprises two sleeves, two blocking pieces, two pull rods, and two springs; the two sleeves respectively sleeve two ends of the chain; the two blocking pieces and the two springs are respectively accommodated in the two sleeves; each of the sleeves comprises a step portion, the two blocking pieces are abut against the step portions of the corresponding sleeves, one end of each of the two springs abuts against the corresponding sleeve, and the other end abuts against the corresponding blocking piece; each of the two blocking pieces comprises a bored hole; and two ends of the chain respectively pass through the bored holes of the two blocking pieces to be connected to the two pull rods, respectively.

3. The reciprocating type pull rod driving apparatus according to claim 2, wherein the operating assembly further comprises a connecting member and an elastic restoring element; the two sleeves are connected to each other through the connecting member; and two ends of the elastic restoring element are respectively connected to the connecting member and the housing.

4. The reciprocating type pull rod driving apparatus according to claim 1, further comprising a chain detachment mechanism disposed in the housing, wherein when the driving wheel is driven to rotate by the chain, the quantity of the plurality of engagement teeth of the driving wheel that the chain is engaged with is less than or equal to a half of the total quantity of the plurality of engagement teeth; and when the driving wheel is not rotating, the chain detachment mechanism pushes out the chain and makes the chain be at least partially disengaged from the plurality of engagement teeth.

5. The reciprocating type pull rod driving apparatus according to claim 4, wherein the chain detachment mechanism comprises a U-shaped baffle and an elastic body; the driving wheel comprises an outer circumferential groove in communication with the plurality of engagement teeth; the U-shaped baffle is sleeved in the outer circumferential groove of the driving wheel and configured to slide relative to the driving wheel; the elastic body is accommodated in the housing, with one end abutting against the housing and the other end abutting against the U-shaped baffle; and the elastic body constantly drives the U-shaped baffle to push out the chain and makes the chain be at least partially disengaged from the plurality of engagement teeth.

6. The reciprocating type pull rod driving apparatus according to claim 5, further comprising another driving wheel, another chain, another operating assembly, another U-shaped baffle, and another elastic body, wherein the another driving wheel is kinematically connected to the shaft rod; the another driving wheel comprises a plurality of engagement teeth and an outer circumferential groove; the another chain is engaged with the plurality of engagement teeth of the another driving wheel; the another operating assembly is connected to the another chain and suitable for operating the another chain to drive the another driving wheel to rotate; the another U-shaped baffle is sleeved in the outer circumferential groove of the another driving wheel and configured to slide relative to the another driving wheel; the another elastic body is accommodated in the housing, with one end abutting against the housing and the other end abutting against the another U-shaped baffle; wherein a distance between a radial outer end edge of the another driving wheel and an inner wall of the housing is greater than or equal to a thickness of the another chain; when the another driving wheel is driven to rotate by the another chain, a quantity of the plurality of engagement teeth of the another driving wheel that the another chain is engaged with is less than or equal to a half of a total quantity of the plurality of engagement teeth; and when the another driving wheel is not rotating, the another chain detachment mechanism pushes the another chain out of the plurality of engagement teeth of the another driving wheel, so that the another chain is at least partially disengaged from the plurality of engagement teeth.

7. The reciprocating type pull rod driving apparatus according to claim 6, wherein each of the operating assemblies comprises two sleeves, stop blocks, pull rods, and springs; the pull rods are respectively connected to one end of the chains; each of the stop blocks is respectively connected to the other end of the chains; the sleeves respectively sleeve two ends of the chains; the springs are respectively accommodated in the sleeves; one end of the springs respectively abuts against the sleeves, and the other end abuts against the stop blocks or the pull rods; the pull rods of the operating assembly are configured to drive the driving wheel to rotate clockwise; and the pull rods of the another operating assembly are configured to drive the another driving wheel to rotate anticlockwise.

8. The reciprocating type pull rod driving apparatus according to claim 6, further comprising a driven wheel arranged on the shaft rod and kinematically connected to at least one of the driving wheel and the another driving wheel, wherein when at least one of the driving wheel and the another driving wheel rotates, the driven wheel is driven to rotate.

9. A curtain system, comprising:
the reciprocating type pull rod driving apparatus according to claim 1; and
curtain cloth, wound onto or unwound from the shaft rod by being driven by the reciprocating type pull rod driving apparatus.

10. The curtain system according to claim 9, further comprising a fixed bracket, wherein the reciprocating type pull rod driving apparatus is arranged on the fixed bracket; the fixed bracket comprises a limiting member; the curtain cloth is provided with a stop member; and when the curtain cloth is wound onto the shaft rod and the stop member abuts against the limiting member, the shaft rod is incapable of further winding the curtain cloth.
